(19) United States
(12) Patent Application Publication
(10) Pub. No.: US 2004/0213876 A1
(43) Pub. Date: Oct. 28, 2004

(54) Meat and seafood preservation process

(76) Inventors: Blane E. Olson, Dunwoody, GA (US); Douglas B. Brinsmade, Atlanta, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/853,600

(22) Filed: May 25, 2004

Related U.S. Application Data
(63) Continuation-in-part of application No. 09/874,885, filed on Jun. 5, 2001, now Pat. No. 6,777,012.

(51) Int. Cl. A01K 1/00

(52) U.S. Cl. 426/321

(57) ABSTRACT

The preservation of fish and meat products is accomplished utilizing a combination of smoke, ozone and optional freezing preservation techniques. Particularly, fish or meat products are sized into portions that are first treated with smoke, followed by treatment with ozone and then optionally frozen. The preservation system extends the shelf life of the fish or meat products and permits the fish or meat product to maintain its freshness and freedom from bacterial decomposition for a longer period of time following catch or slaughter. The preservation process further maintains the characteristics of day caught fish or freshly slaughtered meat, such as taste, texture and color, making the refreshed fish or meat products produced by the present system more appealing to consumers.

### CROSS-REFERENCE TO RELATED APPLICATION

This is a continuation-in-part of U.S. patent application Ser. No. 09/874,885 filed Jun. 5, 2001 entitled Seafood Preservation Process. This application claims priority to U.S. provisional application entitled, “Seafood Preservation Process,” having Ser. No. 60/241,921, filed Oct. 20, 2000.

### TECHNICAL FIELD

The present invention is generally related to the preservation of seafood, meat and other food products for consumer consumption, and more particularly is related to a process for preserving these food items by treating them with smoke and ozone to retard degradation of freshness attributes such as color pigmentation and bacterial decomposition. The food products may remain in the fresh state until cooked. Also, because of the preservation process, the preserved food product can be frozen and defrosted at a later date, and it retains more of the freshness attributes than would normally be retained by frozen products had the preservation process not been used.

### BACKGROUND OF THE INVENTION

The preservation of meat, fish and other food items is a major concern for food processors, distributors and retailers. Originally man salted and dried food to preserve it. Since the advent of mechanical refrigeration, fish and meat have been preserved by freezing, canning and refrigeration, thus permitting distribution of fish and meat over longer times and distances.

The length of time over which a fish or meat item maintains its freshness is commonly referred to as its shelf life. The shelf life of fish and meat is determined by a number of factors, including the total number of each type of bacteria initially present, the specific types of bacteria present, the temperature of the flesh of the fish or meat and of the surrounding atmosphere, and the pH of the flesh. It is well known that to extend the shelf life of fish or meat, one may, for example, reduce the number of bacteria present using chemical means, freezing or other methods, create an acidic pH and/or maintain the product below 5° C. in its fresh state.

The most common process employed to extend the shelf life of fish or meat beyond a few days is freezing. An inherent problem with freezing fish or meat is its loss of the “fresh” attributes such as a “pink” or “red” color to meat or fish flesh due to oxidation of the Fe+ ion in the heam pigment found in the myoglobin of the flesh. The loss of these attributes causes the value of the frozen fish or meat to be much less than the value of fish or meat that has not been previously frozen. This loss of value is an interpretation of the quality of the fish or meat by the consumer. The color of the flesh or fish or meat is a major factor in the selling of these items at the consumer level. Most consumers purchase fish or meat with their “eyes” rather than with any other factor, such as smell, taste or texture. Therefore, it is desirable to maintain the “fresh” pink/red color of these products as long as possible in order to sell the product at a premium to consumers, or recover these colors after the product has been frozen and thawed.

Although many factors may effect changes to the color of fish or meat products, the main reduction of color results from damage to the hemoglobin pigments in the myoglobin of the flesh. Several of the primary causes for the reduction of hemoglobin pigments, resulting in a corresponding reduction in the “fresh” color of the fish or meat, include oxidation of the “red” hemoglobin pigments in the flesh to a “brown” color; bacterial decomposition of the cells containing the hemoglobin pigments; and destruction and oxidation of the hemoglobin pigment during freezing.

Most unfrozen fish or meat is still considered “fresh” for as many as. 30 days from catching or slaughtering. However, unfrozen fish or meat this old usually contains high levels of dangerous bacterial decomposition. Bacterial decomposition is the cellular breakdown of the flesh of the fish or meat due to the digestive enzymes of bacteria present on or within the flesh. Conversely, frozen fish and meat is usually frozen upon catching or slaughtering which reduces the likelihood that the fish or meat will contain significant or harmful levels of bacterial decomposition.

In order to preserve the freshness of the fish or meat and maintain the color of the flesh and blood line to a satisfactory consumer level, processes using smoking and freezing techniques have been applied.

Smoking of food has been one of the major forms of food preservation for centuries. Smoking involves the burning of organic substances, such as wood, to produce a complex mix of over 400 separate chemical compounds. These compounds, when continually exposed to flesh, are absorbed into the flesh over time and impart a smoke flavor to the flesh. The smoke compounds act as a natural “bacteriostat” and greatly increase the refrigerated shelf life of the flesh, up to three times the un-smoked shelf life. Smoking of flesh increases the shelf life by killing a majority of the bacteria initially present, and then creating an acidic environment that slows the growth of bacteria over time in refrigerated conditions. The compounds in the smoke that are primarily responsible for the extension of the shelf life are the aldehydes and phenols, as well as CO, CO₂, NO, NO₂, which are the main gaseous components of smoke. These compounds maintain the “fresh” color of the flesh, as well as retard the growth of bacteria both on the surface of the fish and within the flesh.

However, one of the problems inherent in smoking to impart preservation properties, is that the smoke odor and/or smoke taste remains present in the flesh. Additionally, smoke that is produced from organic fuel materials typically contains particulates, such as creosote, tar, soot, etc., which are undesirable elements to have in contact with food products. Thus, it is beneficial to provide a smoke that has had some of the particulate removed, and then further remove the smoke odor/taste in a later processing step while still maintaining the extended shelf life.

U.S. Pat. No. 5,972,401 to Kowalski discloses a process for manufacturing a tasteless, super-purified smoke for the treatment of seafood and meat. The super-purified smoke is then applied to seafood or meat to preserve the freshness, color, texture, and natural flavor, particularly after the seafood or meat is frozen and thawed. Kowalski teaches that the smoke must be super-purified by filtering out a substantial amount of odor and taste imparting particulate matter and gaseous vapors, thereby recovering the smoke in a tasteless form. Thus, Kowalski is limited in that it requires that the smoke be super-purified into a tasteless form in order to prevent the impartation of the smoke odor or taste to the seafood or meat products.

U.S. Pat. No. 5,484,619 to Yamaoka discloses a process for smoking fish and meat at low temperatures, thereby conferring a smoked flavor and taste, and further preventing decomposition and discoloration of the fish or meat. As in Kowalski, the smoke is filtered to remove the larger particulates and provide a smoke that will preserve, sterilize and aid in maintaining the color of the flesh of the fish or meat. However, Yamaoka teaches that the smoke odor or taste will remain in the fish or meat and that the temperature of application of the smoke is important. Specifically, the Yamaoka smoke preservation process must be carried out at extremely low temperatures (between 0 and 5° C.) in order to maintain the freshness and quality of the fish or meat products. Therefore, Yamaoka is limited to a smoke process for preserving fish or meat products wherein the product will retain a smoke odor or taste, and the process is further limited to a narrow range of temperature conditions.

U.S. Pat. No. 2,120,237 to Brenner et al. discloses a method for partially drying and then smoking fish fillets to preserve them. The fish fillets were first dried to remove a substantial portion of the moisture present and then treated within a smoke atmosphere. This method imparted a smoke flavor to the dried fillets and aided in the prevention of the fish deterioration.

It is also known to preserve the freshness or color of fish or other meat products by several other methods of treatment. U.S. Pat. No. 3,859,450 to Alsina teaches that melanosis (blackening) in shellfish is prevented by application of an innocuous acid solution followed by carbon dioxide gas. The resultant chemical reaction between the acid solution and the carbon dioxide produces carbonic anhydride that penetrates the shellfish and prevents melanosis during preservation by freezing. The process also discloses that the use of a food preservative, such as metabisulphite, will prolong the preservation of the original taste and texture of the shellfish after thawing.

U.S. Pat. No. 4,522,835 to Woodruff et al. discloses a process for maintaining good color in meat, poultry and fish products. Specifically, Woodruff teaches that subjecting the product to an atmosphere containing a low oxygen concentration and followed by an atmosphere containing a small amount of carbon monoxide will convert oxymyoglobin to carboxymyoglobin. The process produces a red color in the product and permits lengthy refrigeration of the product (two to three weeks). Further preservation is accomplished by Woodruff by maintaining the product in a modified carbon dioxide atmosphere or by freezing.

U.S. Pat. No. 5,540,942 to Tokoro teaches that the freshness of meat or fish may be improved by treatment with ubidecarenone to prevent discoloration of the product. The ubidecarenone additive prevents the oxidation of the haem pigments, thereby maintaining the red color of “fresh” product by preventing discoloration to a brown or gray appearance.

Ozone, a GRAS (generally regarded as safe) substance, has been used for more than ten years to sanitize, deodorize and prevent bacterial growth in food items. Its main strength is in the killing of surface and subsurface bacteria that lead to decomposition of fish and meat flesh during refrigerated storage. Ozone may be applied using a gaseous or liquid medium or a combination thereof.

U.S. Pat. No. 5,783,242 to Teague discloses a process of treating poultry with ozone and ozone dissolved in water to reduce the population of contaminating organisms. The product is first subjected to a solution containing ozone and then exposed to a gaseous atmosphere containing ozone. The product is also subjected intermittently to UV exposure which further acts as a bactericide and decomposes any ozone remaining on the product into oxygen.

Although, it is known that the foregoing techniques may be used to preserve the fish or meat flesh itself, these techniques often result in an appearance of flesh that has lost its “fresh” attributes. Accordingly, without the ‘pink’ or ‘red’ color of the flesh, consumers often consider such preserved foods as “not fresh,” resulting in a lower sales price for the item. The foregoing techniques claim to maintain the color of the fish or meat do so with the addition of chemical additives and preservatives which can alter the taste and texture of the fish or meat or be toxic in certain dosages to humans. Additionally, maintaining the “fresh” attributes of the fish or meat is not taught when the fish or meat is preserved or further preserved by freezing.

Therefore, a heretofore unaddressed need exists in the industry to satisfy the aforementioned deficiencies and inadequacies and provide a preserved fish or meat that increases the retention of the qualities and characteristics of a ‘fresh’ fish or meat product.

### SUMMARY OF THE INVENTION

Through research and product development, the inventors have devised a process for fish and meat preservation that results in the production of an extremely high quality, fresh fish and meat product line with extended shelf life characteristics. The fish or meat products are preserved using smoke and ozone so as to maintain the qualities and characteristics of freshly caught fish or slaughtered meat.

The process allows the transportation of fresh and frozen fish and meat items from remote areas of the world in a safe, sanitary and economical way. However, Applicants' preservation process has overcome the drawbacks of typical freezing techniques and allows the consumer to receive a high quality, extremely safe product with increased taste, texture and attributes of fresh products. The fish or meat appears “fresh” to consumers as it retains more of its red, or bright, color and is, thus, more appealing.

In general, the process includes the steps of smoking of fresh fish or meat, treating it with ozone and optionally freezing the product. When a smoke and ozone process is utilized, the shelf life is extended and the fish or meat retains more of its “fresh” color. The smoke/ozone process retains the “fresh” color and extends shelf life of the fish or meat flesh by binding the carbon monoxide molecule to the heam pigment in the hemoglobin molecule (creating carboxymyoglin instead of oxymyoglobin) in such a way that it takes much greater than normal oxidative force to oxidize the hemoglobin molecule. Furthermore, the smoke/ozone process aids in the prevention of bacterial decomposition and maintains the hemoglobin molecule (red color) during freezing and frozen storage by binding it with a CO molecule.

The fish or meat item would be placed in a modified “smoke” atmosphere for 1 to 72 hours, with the length of time depending on the thickness of the fish product, with thicker products requiring more time than thinner products. If the smoke is applied to the fish or meat while in a vacuum chamber, the time required for the smoke application can be reduced to less than a minute. Also the injection of the smoke into the fish or meat item using needles will shorten the time necessary for the smoking phase. During the smoking step, a vast majority of “aerobic” bacteria die as there is no oxygen available for them to breathe. The smoking step additionally creates an acidic pH in the flesh by the dissolution of free carbon dioxide, present in the smoke, into the flesh. The acidic pH prevents the growth of bacteria during the “fresh” stages of the process. An optional final step can involve freezing the product to kill an additional percentage of the bacteria present on the product.

The fish or meat product can be initially prepared into appropriately sized sections or fillets in order to accelerate the smoke/ozone application steps.

With the use of this fish or meat preservation process, the shelf life of the product is increased, usually from about 2-3 days after the product is slaughtered to about 10-12 days. This increase in shelf life after the product has been treated allows the product to be shipped to remote areas that require longer shipping times. Also, the final processing of the product into consumer-ready forms, including cutting, portioning and packing the product, can be performed at the central processing facility. This avoids the necessity of having to perform the final processing of the product at the store level.

Other processes, systems, methods, features and advantages of the present invention will be or will become apparent to one with skill in the art upon examination of the following drawings and detailed description. It is intended that all such additional processes, systems, methods, features and advantages be included within this description, be within the scope of the present invention, and be protected by the accompanying claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIGS. 1-3 are schematic elevational views of a vacuum bag and the fish or meat products contained therein, showing the bag in its relaxed, vacuum and inflated configurations, respectively.

FIG. 4 is a schematic view of the smoke machine.

FIG. 5 is a side elevational view of the centrifuge used in the smoke machine.

FIG. 6 is a cross section of the centrifuge, taken along lines 6-6 of FIG. 5.

FIG. 7 is a side view of the bag filling device.

FIG. 8 is a perspective view of the ozone dipping tank and basket.

FIG. 9 is a plan view of the ozone chamber used for fish steaks.

### DETAILED DESCRIPTION OF THE PREFERRED EMBODIMENT

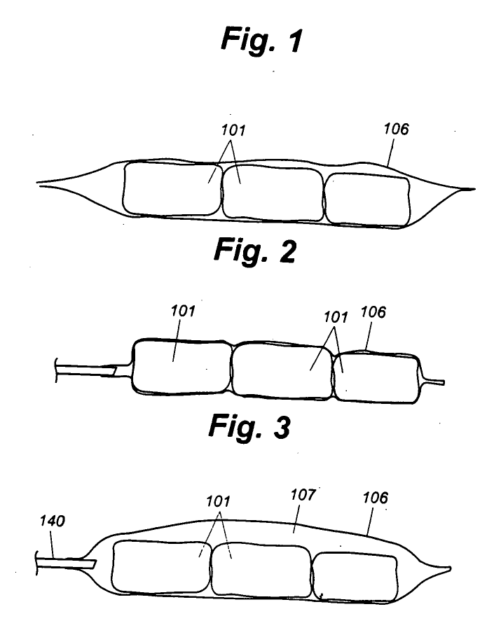

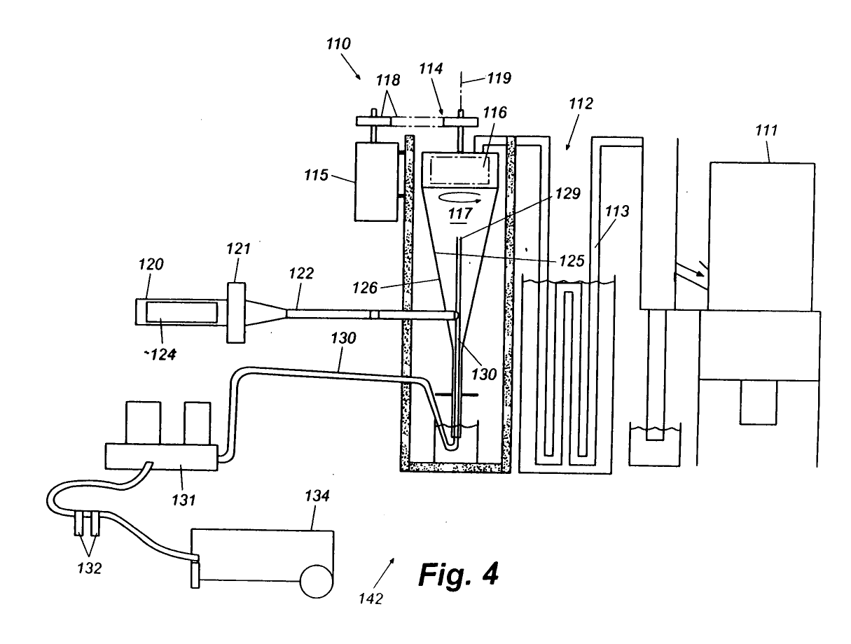

The inventors have devised a process for preserving seafood products and other meat products of various types. Typically, the first step of the process involves the initial preparation of the product into appropriately sized sections 101. The skin and bones may either be removed or may be left on. As shown in FIG. 1, if the product is fish and if the fish is of the pelagic species, such as salmon or tuna, or if meat in the form of a roast or large section of beef, the product can be cut into loin portions or steaks. If any loin portion has a thickness that is too big for expedient smoke and/or ozone treatment, the loins can be cut into steaks.

As shown in FIG. 1, the dry fish products 101 are inserted into a vacuum bag 106 or another type of container in a single layer of the products. It is acceptable for the products to come in contact with each other. As shown in FIG. 2, the vacuum bag 106 or other type of vacuum container is vacuum sealed about the products using a nozzle such as a hollow needle 140 of a conventional vacuum packaging machine (not shown). The vacuum seal formed about the products should be tight enough to remove substantially all of the air from the container 106, but not so tight as to damage or flatten the fish product.

Once the air has been removed from the sealed container 106, a valve leading to the nozzle 140 is changed so that the nozzle communicates with a container (not shown) that is filled with filtered smoke 107 and smoke moves through the nozzle into the bag, as shown in FIG. 3. The container 103 should be filled through the same nozzle 140 with smoke until there is a slight pressure in the container. The container should remain sealed, such as with heat sealing of the layers of a plastic bag together or tying tightly, to prevent any of the smoke from exiting the bag 106.

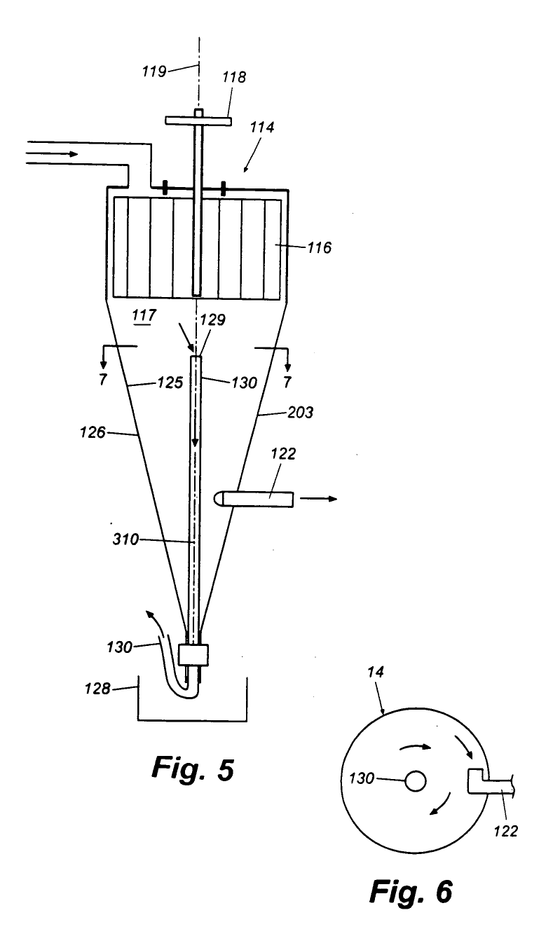

The smoke can be generated by a smoke machine 110, as shown in FIG. 5. The smoke machine 110 includes a smoke generator 111, a smoke cooler 112, a centrifugal precipitator or centrifuge 114, motor 115, a centrifuge fan 116 and connecting belt and sheaves 118. Motor 115 rotates centrifuge fan through the belt and sheaves in a conventional arrangement. Dirty smoke draw chamber 120 and its suction fan 121 draw the dense or dirty smoke from the centrifuge through mid height exhaust conduit 122, and push the smoke through a filter 124 to the atmosphere. Some of the heavier precipitates of the smoke will move down the converging interior wall 125 of the centrifuge housing 126 through the open bottom to a water trap 128.

The clean smoke is gathered at the vertical axis of the converging conical interior wall of the centrifuge by the inlet opening 129 of the clean smoke exhaust conduit 130. The clean smoke exhaust conduit leads to clean smoke exhaust compressor 131, through filters 132 to smoke storage tank 134.

It would be apparent to one skilled in the art to modify the aforementioned embodiment of the smoke machine 110 by the addition or deletion of certain devices without substantially altering the purpose of supplying a filtered smoke. The smoke generator 111 is of conventional construction and is adapted for the burning of wood or other organic material for the generation of smoke. Operating temperatures of the machine range from 400 degrees F. to 1100 degrees F. The smoke is passed from the smoke generator 111 through the smoke cooling conduits 113 of the smoke cooler 112. Cold water is circulated about the smoke cooling conduits to chill the smoke from about 900 degrees F. as it exits the smoke machine to about 100 degrees F. before moving into the centrifuge.

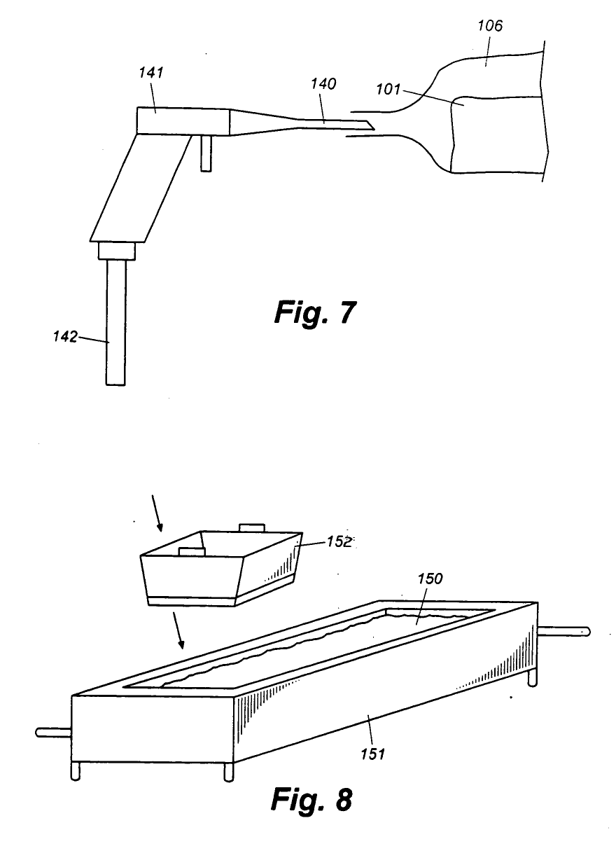

After the smoke has been generated by the smoke generator 111 and passed through the smoke cooler 112, it is passed through the centrifuge 114. The centrifuge 114 removes the majority of the particulate phase, i.e. any particle larger than approximately one micron, of the smoke. The particulate phase, which contains mainly ash and tar, is removed by running the product through the centrifuge 114 (see FIGS. 6 and 7 showing typical centrifuge design and implementation). The centrifuge 114 creates a cyclone effect inside the main chamber 117 by spinning a “squirrel cage” fan blade 116 at a speed of approximately between 3600 and 4000 rpm. The spinning action causes the heavy particulates of the smoke, mainly tar, to be flung by centrifugal force against the inside surface of the perimeter wall 125 of the chamber 126 at high velocity. The heavy particulates then move down the inside wall and funnel down to a collecting receptacle or water trap 128 at the bottom of the conical chamber 126. The collecting receptacle 128 is partially filled with water at the lower open end of the centrifuge 114 so as to trap the heavy smoke particulates being exhausted by the precipitator. With the heavy particulate phase removed, the lighter, cleaner smoke at the center of the vertical axis 119 of the centrifuge 114 enters the outflow pipe and is directed into the smoke storage tank 134.

Excess uncleaned smoke is directed through mid height exhaust conduit 122 and through exhaust suction fan 121. Fan 121 is a variable speed fan that regulates the amount of smoke drawn through the system.

The clean smoke is dispensed on demand from the centrifuge 114 by the compressor 131. The resulting clean smoke exits the centrifuge 114 with a very clear appearance. It is directed by the compressor 131 and its connection hoses through a final filtering device 132 and is collected and maintained in a smoke storage tank 134. When a smoke storage tank is filled with smoke it is stored for later use.

As illustrated in FIG. 7, the cleaned smoke is later inserted into the vacuum bag 106 with the fish product 101 by placing the hollow needle 140 of an air chuck 141, which is connected to the smoke storage tank 134 via clean smoke dispensing conduit 142, into the bag 106 and pulling the trigger mechanism 144. This opens a valve and allows the clean smoke to move into the vacuum bag 106. For high volume production, the bag 106 can be filled by using a modified atmosphere packaging system like the CVP AT600. If another type of vacuum chamber is used, not a bag, the smoke can be dispensed into the chamber by using a valve controlled conduit.

The filtered smoke will have an initial level of CO/CO₂ in the vacuum chamber and the CO/CO₂ level should be periodically measured. When the CO/CO₂ level begins to decline appreciably, the vacuum chamber is voided of and refilled with smoke until the color characteristics of the fish have stabilized. This procedure should preferably occur at a temperature range of 0 degrees C. to 5 degrees C. and can take anywhere from 1 minute to 72 hours depending on the type of fish or meat product and the characteristics of the smoke and the method of applying the smoke. After this, the smoked fish or meat product is placed in an ozonated environment at a temperature range of about 0 degrees C. to 5 degrees C. and is maintained in the ozonated environment until the odor of smoke is no longer detectable. Depending on the type of fish product and the amount of smoke odor that the product has absorbed during the smoking step, it may take anywhere from 8 seconds to 72 hours depending on the type of fish product, the characteristics of the smoke, and the method of applying smoke, for the smoke odor to be sufficiently diminished that it is no longer detectable. The fish product is then removed, vacuum sealed and can be optionally frozen using conventional freezing techniques. When it is desired to use or display the fish product, the fish product is defrosted. The present process for preserving the fish product results in a refreshed fish product that closely parallels a day caught fish in quality, characteristics and appearance.

When the decline of the CO/CO₂ level slows appreciably during the smoke application process, the remaining smoke should be removed from the vacuum chamber 106 and replaced with another charge of smoke, as might be necessary. The smoking step should be repeated until the color characteristics of the fish or meat product 101 have stabilized.

Depending on the type of fish or meat product 101, the temperature and the smoke characteristics, it may take between approximately one to seventy-two hours at atmospheric pressure to satisfactorily complete the smoking step. However, if the smoke is applied in a vacuum chamber at a reduced pressure to the product, the smoke application step can be performed in minutes. The same applies if the fish or meat item has the smoke injected directly into the center of the product using needles.

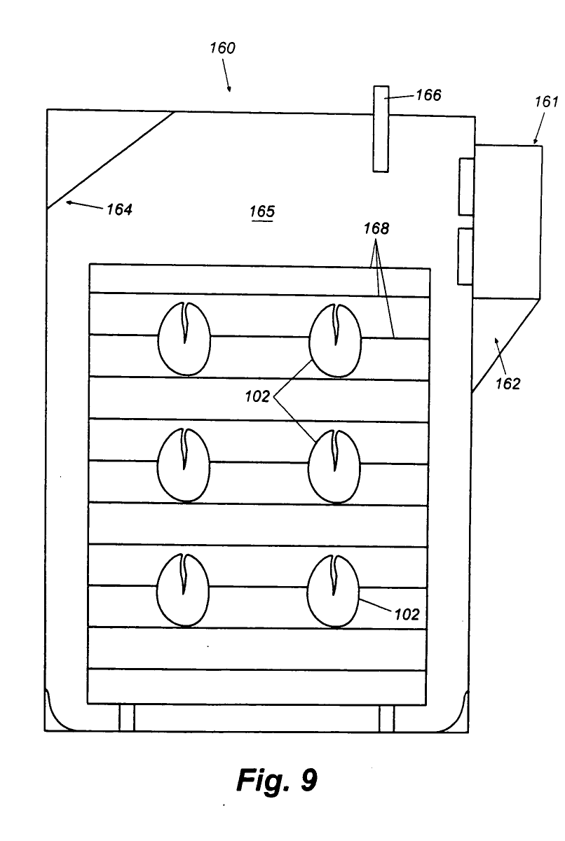

Once the smoking step is complete, the fish or meat product 101 is removed from the vacuum chamber 106 and may be patted dry using a porous plastic sponge, or the like, sanitized with alcohol. The product is checked for smoke odor. As shown in FIG. 9, the fish product 101 is then placed in a basket 150 or other porous tray device. The fish or meat product 101 may be situated within the basket 150 in either a single or double layer configuration. The basket 150 is then immersed into an ozone dipping tank 151, that contains chilled (at about 5° C.) ozonated water 152 (approximately 2 ppm ozone) for between approximately one minute and one hour. The product can be left in the ozonated water for more than one hour, if desired.

The odor of the fish or meat product 101 is periodically monitored by removing the basket 150 from the ozonated water 152 and sniffing to detect a smoke odor. At the point that the smoke odor is no longer noted, the fish product 101 should be removed from the ozonated water 152 and any excess ozonated water 152 should be allowed to drain away from the basket 150.

The fish or meat product 101 can be left unfrozen and enter into commerce, or can be frozen for even longer shelf life, using conventional freezing techniques. If frozen, the fish or meat product 101 should be stored and maintained at temperatures below −18° C.

When the use of the frozen fish or meat product 101 is desired, the product is defrosted by either placing the product in a cooler between 2 and 5° C. or by placing the bag in a basin of cold water. The refreshed fish or meat product 101 will substantially retain the quality and characteristics of a freshly slaughtered product and may then be displayed or maintained at refrigerated temperatures for up to six more days.

If the fish product 101 is tuna, or other pelagic species, or some types of meat product, the ozone step is applied using a different technique. As shown in FIG. 10, instead of using the ozone dipping tank 151, pelagic fish steaks or meat steaks 102 can be ozonated in an ozone chamber 160 for better results. FIG. 6 illustrates an ozone chamber ozonated for better results. FIG. 9 illustrates an ozone chamber 160 having an ozone generator 161, intake 162, deflector 164, chamber 165, exhaust 166 and product holding rack 168. After the fish or meat steaks 102 have been smoked and optionally wiped with an alcohol soaked sponge, the fish or meat steaks 102 are placed on racks 168 in the ozone chamber 165. The fish or meat steaks 102 should remain in the ozone chamber 165 for approximately one minute to four hours or until they reach the desired reduced level of smoke odor. Once the fish or meat steaks 102 have been ozonated, they can be placed in a vacuum bag and vacuum sealed or wrapped in any type of packaging media. For freezing they are placed in a vacuum bag and are vacuum sealed or individually poly wrapped. For fresh products, the fish or meat item is placed in distribution-ready packaging.

Although the aforementioned embodiments were directed to fish products in prior work, much work has subsequently been done by the inventors that the claimed preservation process may be applied with equally satisfactory results for fish, beef, pork, poultry and crustaceans. Additionally, the methods for applying the smoke and ozone, and for freezing may be varied from those specifically disclosed herein.

Particularly, it is anticipated by the inventors that the smoke may be applied under atmospheric, vacuum or pressured conditions and in any suitable containment vehicle, including heated or refrigerated conditions. The smoke itself may be comprised of any smoke suitable for treatment of food products for human consumption, may be generated by any number of means including, but not limited to, combustion, transformation between solid or liquid state to gaseous state, friction, pyrolysis, aerobically, anarobically, electrostatic force, or other known means of separating out a component of smoke. The smoke may be applied to the products in an open, batch, closed or flow-through system.

Likewise, the ozone treatments disclosed above in the preferred embodiments are not exclusive. The inventors anticipate that the ozone may be applied using any type of carrier medium including, but not limited to, air, gases, water, fluids or solids and under atmospheric, vacuum or pressured environments and in any suitable containment vehicle, including heated or refrigerated conditions. The ozone that is applied is not limited to “pure” ozone, but may be in reaction form, mixtures, solutions or other form. The ozone may be applied to the products in an open, batch, closed or flow-through system.

The freezing step of the preservation process may be accomplished using any number of conventional freezing applications. Particularly, it is anticipated by the inventors that suitable freezing can occur under atmospheric, vacuum and pressured conditions in gaseous, liquid or solid freezing mediums or combinations thereof.

While the process described herein involves the treatment of fresh fish or fresh meat, a similar process can be applied to frozen fish or frozen meat. One such process is to thaw the frozen fish or meat and later apply the smoke and ozone to the product. A preferred process of treating the frozen product is to simultaneously thaw and smoke the fish or meat in a chamber. This can be done in a vacuum chamber. This eliminates the exposure of the fish or meat to standard atmosphere as it thaws.

It should be emphasized that the above-described embodiments of the present invention, particularly any “preferred” embodiments, are merely possible examples of implementations, merely set forth for a clear understanding of the principles of the invention. Variations and modifications may be made to the above-described embodiments of the invention without departing from the spirit and principles of the invention. All such modifications and variations are intended to be included herein within the scope of this disclosure and the present invention and protected by the following claims.

1. A process for treating meat and fish products for increasing shelf life of the products, by preserving the color and freshness characteristics and unoxidized state of the products, comprising the steps of:
subjecting the products to smoke to apply smoke to the products for a period sufficient to preserve the color, freshness characteristics, and unoxidized state of the products,
removing the smoke from about the smoked products,
subjecting the smoked products to ozone,
removing the ozone from about the ozonated products,
so that the combination of smoke and ozone applications is sufficient that the color of the products, freshness characteristics, and unoxidized state of the products is extended compared to fish or meat products that have not been subjected to the smoke and ozone process.

2. The process of claim 1, wherein the step of subjecting the products to smoke comprises subjecting raw uncooked products to smoke, and further including the step of before the products are subjected to the smoke and ozone, cutting the products into portions that are a size and shape that the smoke will permeate into and substantially through the products.

3. The process of claim 1, wherein the step of subjecting the products to ozone comprises injecting the ozone into the products.

4. The process of claim 1, and further including the step of freezing the products before the products are subjected to the smoke and ozone.

5. The process of claim 1, and further including the step of freezing the products before the products are subjected to the smoke and ozone, and wherein the step of subjecting the products to smoke comprises simultaneously thawing the fish and meat products and applying the smoke to the products.

6. The process of claim 1, and further including the step of freezing the products before the products are subjected to the smoke and ozone, and wherein the step of subjecting the products to smoke comprises thawing the fish and meat products before applying the smoke to the products.

7. The process of claim 1, wherein the step of subjection of the product to smoke comprises cleaning of the smoke by removing a portion of the particulate in the smoke prior to applying the smoke to the products.

8. The process of claim 1, wherein the step of subjection of the products to smoke comprises super purifying said smoke to reduce taste imparting components below thresholds for imparting smoke odor and taste to the product.

9. The process of claim 1, wherein the step of subjecting the products to smoke comprises placing the products in a container or chamber, removing air from the container of chamber, and introducing the smoke into the container or chamber.

10. The process of claim 1 and further including the step of marinating the products before the step of subjecting the products to smoke.

11. The process of claim 9 and further including the step of, before the step of subjecting the products to smoke, cleaning the smoke by removing a portion of or all of the particulate in the smoke before the products are subjected to the smoke.

12. The process of claim 1, wherein the step of subjecting the products to smoke comprises injecting the smoke into the products.

13. The process of claim 1, wherein the step of subjecting the products to smoke comprises injecting the ozone into the products.

14. The process of claim 1, wherein the step of subjecting the products to ozone comprises subjecting the products to ozone through a carrier medium.

15. The process of claim 14, wherein the ozone is applied to the products in a containment chamber.

16. The process of claim 1, wherein the step of subjecting the fish or meat products to ozone comprises reducing the atmosphere about the products to a pressure less than atmospheric pressure and introducing the ozone to the products in the reduced atmosphere.

17. The process of claim 1, and further including the step of freezing the products following the step of subjecting the products to ozone.

18. The process of claim 1, wherein the steps of subjecting the smoke to the products and removing the smoke from about the products is repeated.

19. The process of claim 1, wherein the steps of subjecting the products to ozone and removing the ozone from about the products is repeated.

20. The process of claim 1, wherein the step of subjecting the fish or meat product to smoke comprises placing the product in a disposable or reusable plastic container.

21. A process for treating meat and fish products for increasing shelf life of the products, by preserving the color and freshness characteristics and unoxidized state of the products, comprising the steps of:
cutting the products into portions that are of a size that smoke will permeate into the products,
placing the cut products in a container,
generating smoke from an organic substance,
cleaning the smoke by removing some of the particulate from the smoke,
reducing the pressure of the atmosphere in the container about the products,
while the atmosphere in the container is reduced, introducing cleaned, chilled smoke into the container,
subjecting the products in the container to the cleaned and chilled smoke for a period sufficient for the smoke to permeate the products and to preserve and substantially maintain the color, freshness characteristics, and the unoxidized state of the products,
after the products have been smoked, subjecting the smoked products to ozone for a period sufficient for the ozone to substantially remove smoke odor from the products and sufficient to reduce the existing bacteria on the products,
so that the combination of smoke and ozone applications to the products is sufficient that the color of the products, freshness characteristics, and unoxidized state of the products are extended compared to similar fish or meat products that have not been subjected to a preservation process.

22. The process of claim 21, and further comprising repeating the step of subjecting the products in the container to smoke before subjecting then products to ozone.

23. The process of claim 21, and further comprising inhibiting the growth of bacteria on the product by subjecting the product to ozone.

24. The process of claim 21, wherein the step of placing the product in a container comprises placing the product in a bag, wherein the step of reducing the atmosphere in the container comprises withdrawing air from the bag, and wherein the step of introducing smoke in the container comprises filling the bag with smoke.

25. The process of claim 21, wherein the step of treating the product with ozone is performed by filling a tank with a liquid bearing ozone and immersing the product in the liquid bearing ozone in the tank.

26. A process for treating smoked meat and fish products for increasing shelf life of the products, by preserving the color and freshness characteristics and unoxidized state of the products, comprising the steps of:
subjecting the smoked products to ozone for a period sufficient for the ozone to substantially remove smoke odor from the products and sufficient to reduce the existing bacteria on the products,
so that the combination of smoke and ozone applications to the products is sufficient that the color of the products, freshness characteristics, and unoxidized state of the products are extended compared to similar fish or meat products that have not been subjected to a preservation process.
